(19) United States
(12) Patent Application Publication
(10) Pub. No.: US 2020/0130657 A1
(43) Pub. Date: Apr. 30, 2020

(54) BRAKING CONTROL DEVICE

(71) Applicant: ADVICS CO., LTD., Kariya-shi, Aichi-ken (JP)

(72) Inventors: Ryota ISOBE, Takahama-shi, Aichi-ken (JP); Tetsuaki TSUZUKI, Gamagori-shi, Aichi-ken (JP); Kazuma KONDO, Aichi-gun, Aichi-ken (JP)

(73) Assignee: ADVICS CO., LTD., Kariya-shi, Aichi-ken (JP)

(21) Appl. No.: 16/629,989

(22) PCT Filed: Jul. 31, 2018
(86) PCT No.: PCT/JP2018/028613

§ 371 Date: Jan. 10, 2020

(30) Foreign Application Priority Data
Jul. 31, 2017 (JP) 2017-148653

(51) Int. Cl. B60T 8/172; B60T 8/32; B60T 8/171; B60T 13/74

(52) U.S. Cl. CPC B60T 8/172; B60T 8/321; B60T 2240/00; B60T 13/74; B60T 2210/20; B60T 8/171

(57) ABSTRACT

A braking control device applicable to a vehicle having an electric parking brake with a motor-driven wheel braking mechanism includes a control unit, an offset estimation unit, and an offset correction unit. Based on a target motor current value indicating a target value of current to be inputted to the motor and a detection value from a current sensor that detects the current to be inputted to the motor, the control unit controls the current to the motor such that the detection value equals the target motor current value. The offset estimation unit determines an offset estimation value indicating an estimated value of offset of the detection value from the current sensor, based on behavior of the vehicle after lock control at the time of the vehicle's stoppage. The offset correction unit corrects the target motor current value or the detection value based on the offset estimation value.

### TECHNICAL FIELD

The present invention relates to a braking control device.

### BACKGROUND ART

In recent years, an electric parking brake (hereinbelow, also referred to as ‘EPB’) is adopted for a variety of vehicles such as automobiles. A braking control device configured to control the EPB is configured to generate parking brake force by driving a wheel brake mechanism with a motor, for example.

Specifically, for example, when generating the parking brake force, the braking control device determines a target motor current value, which is a target value of current to be input to the motor, and controls the current to be input to the motor so that a detection value of the current from a current sensor configured to detect the motor current is equal to the target motor current value.

### CITATION LIST

### Patent Literature

PTL 1: JP-A-2014-19235

### SUMMARY OF INVENTION

### Technical Problem

However, the detection value of the motor current from the current sensor may include an offset (detection error). Therefore, in the related art, it is necessary to seta slightly high target motor current value, considering a tolerance of the detection value of the motor current, so that improvements are required.

It is therefore an object of the present invention to provide a braking control device in which it is not necessary to set a slightly high target motor current value, for example.

### Solution to Problem

The present invention provides, for example, a braking control device to be applied to a vehicle provided with an electric parking brake having a wheel brake mechanism to be driven by a motor, and includes a control unit, an offset estimation unit, and an offset correction unit. The control unit is configured to execute motor current control of controlling, on the basis of a target motor current value, which is a target value of current to be input to the motor, and a detection value from a current sensor configured to detect the current to be input to the motor, the current to be input to the motor so that the detection value from the current sensor is equal to the target motor current value. The offset estimation unit is configured to determine an offset estimation value, which is an estimated value of an offset of the detection value from the current sensor, on the basis of a behavior of the vehicle after lock control at the time of vehicle's stoppage. The offset correction unit is configured to correct the target motor current value or the detection value from the current sensor on the basis of the offset estimation value.

### BRIEF DESCRIPTION OF DRAWINGS

FIG. 1 is a pictorial view depicting an overall outline of a brake device for a vehicle in accordance with an embodiment.

FIG. 2 is a pictorial sectional view of a wheel brake mechanism of a rear wheel system provided to the brake device for a vehicle.

FIG. 3 is an image view depicting magnitudes of target motor current values and the like in Comparative Example and the embodiment.

FIG. 4 is a flowchart of lock control processing that is to be executed by a braking control device of the embodiment.

FIG. 5 is a map 1 depicting a relation between a sloping road gradient and a target motor current initial value.

FIG. 6 is a map 2 depicting a relation between a slide-down degree and a target motor current increase amount.

FIG. 7 is a flowchart depicting detailed slide-down preventing lock control processing of the overall flowchart of the lock control processing.

FIG. 8 is a flowchart depicting detailed lock/release indication processing of the overall flowchart of the lock control processing.

FIG. 9 is a timing chart depicting an example of a case of increasing the target motor current value.

### DESCRIPTION OF EMBODIMENTS

Hereinbelow, an exemplary embodiment of the present invention will be disclosed. A configuration of the embodiment below and operations and results (effects) to be obtained by the configuration are exemplary. The present invention can also be implemented by other configurations than the configuration disclosed below. Also, according to the present invention, it is possible to obtain at least one of diverse effects (including derivative effects) to be obtained by the configuration below.

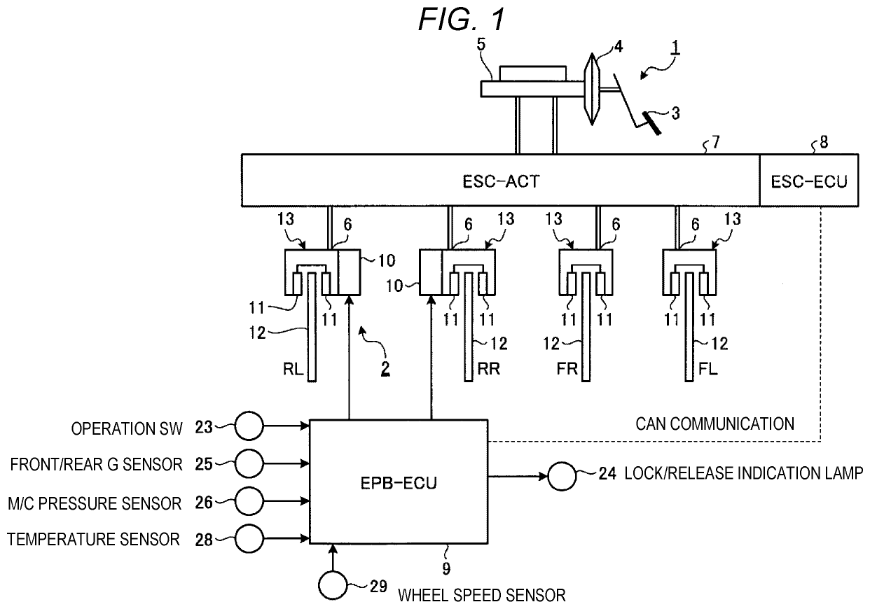

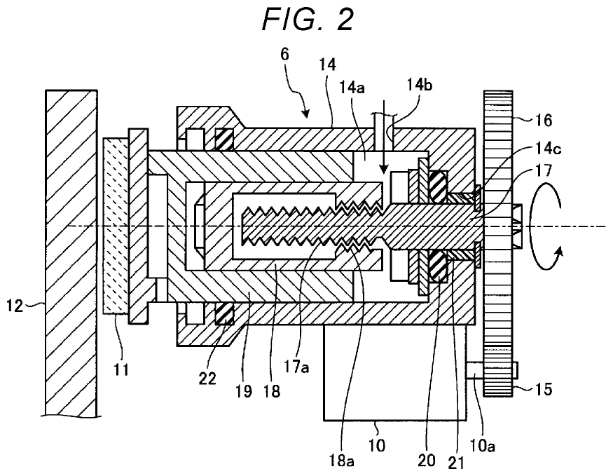

In the embodiment, a brake device for a vehicle in which a disc brake-type EPB is applied to a rear wheel system is exemplified. FIG. 1 is a pictorial view depicting an overall outline of a brake device for a vehicle in accordance with the embodiment. FIG. 2 is a pictorial sectional view of a wheel brake mechanism of a rear wheel system provided to the brake device for a vehicle. Hereinbelow, the embodiment is described with reference to the drawings.

As shown in FIG. 1, the brake device for a vehicle of the embodiment includes a service brake 1 configured to generate service brake force on the basis of driver's stepping force, and an EPB 2 for restraining movement of a vehicle when parking the vehicle, for example.

The service brake 1 is a hydraulic brake mechanism configured to generate a brake hydraulic pressure on the basis of driver's stepping on a brake pedal 3, and to generate service brake force on the basis of the brake hydraulic pressure. Specifically, the service brake 1 is configured to boost stepping force corresponding to the driver's stepping on the brake pedal 3 by a brake booster 4, and to generate a brake hydraulic pressure corresponding to the boosted stepping force in a master cylinder (hereinbelow, referred to as ‘M/C’) 5. The service brake is configured to generate service brake force by transmitting the brake hydraulic pressure to a wheel cylinder (hereinbelow, referred to as W/C) 6 provided to a wheel brake mechanism of each wheel. Also, an actuator 7 for controlling the brake hydraulic pressure is provided between the M/C 5 and the W/C 6. The actuator 7 is configured to adjust the service brake force generated by the service brake 1, and to execute various controls (for example, an antiskid control and the like) for improving safety of the vehicle.

The various controls using the actuator 7 are executed by an ESC (Electronic Stability Control)-ECU 8 configured to control the service brake force. For example, the ESC-ECU 8 outputs control current for controlling various types of control valves and a motor for pump drive (not shown) provided to the actuator 7, thereby controlling a hydraulic circuit provided to the actuator 7 and a W/C pressure to be transmitted to the W/C 6. Thereby, wheel slippage and the like are avoided to improve the safety of the vehicle. For example, the actuator 7 includes, for each wheel, a pressure increasing control valve configured to control applying of the brake hydraulic pressure generated in the M/C 5 or the brake hydraulic pressure generated by the pump drive to the W/C 6 and a pressure reducing control valve configured to supply a brake fluid in each W/C 6 to a reservoir to thereby reduce the W/C pressure, so that it is possible to increase/keep/decrease the W/C pressure. Also, the actuator 7 can implement an automatic pressurization function of the service brake 1, thereby automatically pressurizing the W/C 6 even in a state in which there is no brake operation, on the basis of pump drive and control of the various types of control valves. Since the configuration of the actuator 7 has been well known, the detailed description thereof is herein omitted.

In the meantime, the EPB 2 is configured to generate parking brake force (hereinbelow, simply referred to as “brake force”) by driving the wheel brake mechanism with a motor 10, and include an EPB control device (hereinbelow, referred to as ‘EPB-ECU’) 9 (braking control device) configured to control drive of the motor 10. In the meantime, the EPB-ECU 9 and the ESC-ECU 8 are configured to transmit and receive information by CAN (Controller Area Network) communication, for example.

The wheel brake mechanism has a mechanical structure configured to generate the brake force in the brake device for a vehicle of the embodiment. First, the wheel brake mechanism of a front wheel system has a structure configured to generate the service brake force by an operation on the service brake 1. In the meantime, the wheel brake mechanism of a rear wheel system has a shared structure configured to generate the brake force with respect to an operation on the service brake 1 and an operation on the EPB 2. Since the wheel brake mechanism of the front wheel system is a wheel brake mechanism generally used in the related art, in which the mechanism for generating the parking brake force on the basis of the operation on the EPB 2 is removed from the wheel brake mechanism of the rear wheel system, the description thereof is herein omitted. Hereinbelow, the wheel brake mechanism of the rear wheel system is described.

In the wheel brake mechanism of the rear wheel system, not only when the service brake 1 is actuated but also when the EPB 2 is actuated, brake pads 11 shown in FIG. 2, which are friction materials, are pressed to sandwich a brake disc 12 (12RL, 12RR, 12FR, 12FL) therebetween, which is a material subjected to friction, thereby generating frictional force between the brake pads 11 and the brake disc 12 to generate brake force.

Specifically, the wheel brake mechanism is configured to rotate the motor 10 directly fixed to a body 14 of the W/C 6 for pressing the brake pad 11 as shown in FIG. 2 in a caliper 13 shown in FIG. 1, thereby rotating a spur gear 15 provided to a drive shaft 10a of the motor 10. The rotating force (output) of the motor 10 is transmitted to a spur gear 16 in mesh with the spur gear 15, so that the brake pad 11 is moved to generate parking brake force by the EPB 2.

In the caliper 13, a part of an end face of the brake disc 12 is accommodated with being sandwiched by the brake pads 11, in addition to the W/C 6 and the brake pads 11. The W/C 6 is configured so that a brake hydraulic pressure is introduced into a hollow part 14a of the cylindrical body 14 through a passage 14b and a W/C pressure is thus generated in the hollow part 14a, which is an accommodation chamber of the brake fluid, and includes a rotary shaft 17, a propeller shaft 18, a piston 19 and the like in the hollow part 14a.

The rotary shaft 17 has one end portion coupled to the spur gear 16 through an insertion hole 14c formed in the body 14, so that when the spur gear 16 is rotated, the rotary shaft is rotated in conjunction with the rotation of the spur gear 16. At an end portion of the rotary shaft 17, which is opposite to the end portion coupled to the spur gear 16, an outer peripheral surface of the rotary shaft 17 is formed with a male screw groove 17a. In the meantime, the other end of the rotary shaft 17 is inserted and pivotally supported in the insertion hole 14c. Specifically, an O-ring 20 and a bearing 21 are provided in the insertion hole 14c, so that the brake fluid is prevented from flowing out through a space between the rotary shaft 17 and an inner wall surface of the insertion hole 14c by the O-ring 20 and the other end of the rotary shaft 17 is pivotally supported by the bearing 21.

The propeller shaft 18 is configured by a nut, which is a tube member having a hollow shape, and is formed on its inner wall surface with a female screw groove 18a that is to be screwed with the male screw groove 17a of the rotary shaft 17. The propeller shaft 18 is formed to have a circular cylinder shape or polygonal column shape having a rotation preventing key, for example, so that it is not rotated about a center of rotation of the rotary shaft 17 even when the rotary shaft 17 is rotated. For this reason, when the rotary shaft 17 is rotated, the rotating force of the rotary shaft 17 is converted into force of moving the propeller shaft 18 in an axial direction of the rotary shaft 17 by engagement between the male screw groove 17a and the female screw groove 18a. When the drive of the motor 10 is stopped, the propeller shaft 18 is stopped in the same position by the frictional force due to the engagement between the male screw groove 17a and the female screw groove 18a, and when the drive of the motor 10 is stopped at the time when the target parking brake force is reached, the propeller shaft 18 is held in the corresponding position to keep a desired parking brake force, so that it can be self-locked (hereinbelow, simply referred to as “lock”).

The piston 19 is configured by a bottomed cylindrical member or polygonal tube member disposed to surround an outer periphery of the propeller shaft 18, and is disposed so that an outer peripheral surface thereof is in contact with an inner wall surface of the hollow part 14a formed in the body 14. In order to prevent the brake fluid from being leaked between the outer peripheral surface of the piston 19 and the inner wall surface of the body 14, the inner wall surface of the body 14 is provided with a seal member 22, so that the W/C pressure can be applied to an end face of the piston 19. The seal member 22 is used so as to generate reactive force for returning the piston 19 upon release control after lock control. Since the seal member 22 is provided, even when the brake pad 11 and the piston 19 are pressed within a range of amounts of elastic deformation of the seal member 22 by the brake disc 12 inclined during turning, the brake pad and the piston are pushed and returned toward the brake disc 12, so that a predetermined clearance is kept between the brake disc 12 and the brake pad 11.

Also, in order to prevent the piston 19 from rotating about the center of rotation of the rotary shaft 17 even though the rotary shaft 17 is rotated, in a case in which the propeller shaft 18 is provided with a rotation preventing key, the piston 19 is provided with a key groove in which the key is to be slid, and in a case in which the propeller shaft 18 is formed to have a polygonal column shape, the piston is formed to have a corresponding polygonal tube shape.

The brake pad 11 is disposed at a tip end of the piston 19, and the brake pad 11 is moved in a right and left direction of the drawing sheet, in conjunction with movement of the piston 19. Specifically, the piston 19 can be moved in the left direction of the drawing sheet, in conjunction with movement of the propeller shaft 18, and when the W/C pressure is applied to an end portion of the piston 19 (an end portion opposite to the end portion at which the brake pad 11 is disposed), the piston can be moved independently from the propeller shaft 18 in the left direction of the drawing sheet. When the propeller shaft 18 is located in a release position (a state before the motor 10 is rotated), which is a standby position upon usual release, if the brake hydraulic pressure in the hollow part 14a is not applied (W/C pressure=0), the piston 19 is moved in the right direction of the drawing sheet by elastic force of the seal member 22 (which will be described later), so that the brake pad 11 is separated from the brake disc 12. Also, when the motor 10 is rotated to move the propeller shaft 18 from an initial position in the left direction of the drawing sheet, the movement of the piston 19 in the right direction of the drawing sheet is restrained by the moved propeller shaft 18 even though the W/C pressure becomes zero, so that the brake pad 11 is held at that place.

In the wheel brake mechanism configured as described above, when the service brake 1 is operated, the piston 19 is moved in the left direction of the drawing sheet on the basis of the W/C pressure generated as a result of the operation, so that the brake pad 11 is pressed to the brake disc 12 to generate the service brake force. Also, when the EPB 2 is operated, the motor 10 is driven to rotate the spur gear 15, so that the spur gear 16 and the rotary shaft 17 are correspondingly rotated. Therefore, the propeller shaft 18 is moved toward the brake disc 12 (in the left direction of the drawing sheet) on the basis of the engagement between the male screw groove 17a and the female screw groove 18a. In conjunction with the movement, the tip end of the propeller shaft 18 is contacted to a bottom of the piston 19 to press the piston 19 and the piston 19 is thus moved in the same direction, so that the brake pad 11 is pressed to the brake disc 12 to generate the parking brake force. For this reason, it is possible to configure the shared wheel brake mechanism for generating the brake force with respect to the operation on the service brake 1 and the operation on the EPB 2.

Also, in the wheel brake mechanism, if the W/C pressure is zero and the brake pad 11 is not pressed to the brake disc 12 yet when the EPB 2 is actuated, or if the propeller shaft 18 is not contacted to the piston 19 yet even though the W/C pressure is generated as the service brake 1 is actuated, the load applied to the propeller shaft 18 is reduced and the motor 10 is driven with substantial no load. When the brake disc 12 is pressed by the brake pad 11 in a state in which the propeller shaft 18 is in contact with the piston 19, the parking brake force by the EPB 2 is generated, load is applied to the motor 10, and a value of motor current to be supplied to the motor 10 is changed in correspondence to a magnitude of the load. For this reason, when a detection value of the current (hereinbelow, also referred to as “motor current value”) from a current sensor (not shown) configured to detect the motor current is checked, it is possible to check a generation state of the parking brake force by the EPB 2 or to recognize the detection value. In the meantime, the detection value from the current sensor may include an offset (detection error). Also, the offset of the detection value from the current sensor may be permanent, not temporary, in many cases. Countermeasures against the offset will be described later.

A front/rear G sensor 25 is configured to detect acceleration G in a front and rear direction (traveling direction) of the vehicle, and to transmit a detection signal to the EPB-ECU 9.

An M/C pressure sensor 26 is configured to detect an M/C pressure in the M/C 5, and to transmit a detection signal to the EPB-ECU 9.

A temperature sensor 28 is configured to detect a temperature of the wheel brake mechanism (for example, the brake disc), and to transmit a detection signal to the EPB-ECU 9.

A wheel speed sensor 29 is configured to detect a rotating speed of each wheel, and to transmit a detection signal to the EPB-ECU 9. In the meantime, the wheel speed sensor 29 is individually provided to each wheel but is not here described and shown in detail.

The EPB-ECU 9 is configured by a well-known microcomputer having a CPU, a ROM, a RAM, an I/O and the like, and is adapted to execute parking brake control by controlling the rotation of the motor 10 in accordance with a program stored in the ROM and the like.

The EPB-ECU 9 is configured to input a signal corresponding to an operating state of an operation switch (SW) 23 provided to an instrument panel (not shown) in a vehicle interior, and to drive the motor 10 in correspondence to an operating state of the operation SW 23. Also, the EPB-ECU 9 is configured to execute lock control, release control and the like on the basis of the motor current value, and to recognize on the basis of the control state that the lock control is executed and the wheel is in a lock state by the lock control and that the release control is executed and the wheel is in a release state (EPB release state) by the release control. The EPB-ECU 9 is configured to output a signal, which indicates whether the wheel is in the lock state, to a lock/release indication lamp 24 provided to the instrument panel, in correspondence to a drive state of the motor 10.

The brake device for a vehicle configured as described above basically performs an operation of generating the braking force for the vehicle by generating the service brake force with the service brake 1 during the vehicle traveling. Also, when stopping the vehicle by the service brake 1, the driver performs operations of keeping the stop state by pushing the operation SW 23 to actuate the EPB 2 and to thereby generate the parking brake force and releasing the parking brake force thereafter. That is, when the driver performs an operation on the brake pedal 3 during the vehicle traveling, as an operation of the service brake 1, the brake hydraulic pressure generated in the M/C 5 is transmitted to the W/C 6, so that the service brake force is generated. Also, as the operation of the EPB 2, the motor 10 is driven to move the piston 19, so that the brake pad 11 is pressed to the brake disc 12 to generate the parking brake force and to thereby set the wheel in the lock state or the brake pad 11 is separated from the brake disc 12 to release the parking brake force and to thereby set the wheel in the release state.

Specifically, the parking brake force is generated or released by the lock/release control. In the lock control, the motor 10 is rotated forward to actuate the EPB 2, so that the rotation of the motor 10 is stopped in a position in which the desired parking brake force is to be generated by the EPB 2, and the state is kept. Thereby, the desired parking brake force is generated. In the release control, the motor 10 is rotated reversely to actuate the EPB 2, so that the parking brake force generated by the EPB 2 is released.

Subsequently, specific parking brake control, which is to be executed by the EPB-ECU 9 in accordance with the various functional units and a program stored in an embedded ROM (not shown) by using the brake system configured as described above, is described.

The EPB-ECU 9 is applied to a vehicle provided with an electric parking brake having the wheel brake mechanism to be driven by the motor 10. The EPB-ECU 9 includes, as functional units, at least a control unit, an offset estimation unit, and an offset correction unit. The control unit is configured to execute motor current control of controlling, on the basis of a target motor current value, which is a target value of current to be input to the motor 10, and a detection value from a current sensor configured to detect the current to be input to the motor 10, the current to be input to the motor 10 so that the detection value from the current sensor is equal to the target motor current value.

The offset estimation unit is configured to determine an offset estimation value, which is an estimated value of an offset of the detection value from the current sensor, on the basis of a behavior of the vehicle after lock control at the time of vehicle's stoppage (which will be described in detail later). Also, the offset correction unit is configured to correct the target motor current value or the detection value from the current sensor on the basis of the offset estimation value. Hereinbelow, a case in which the offset correction unit corrects the target motor current value on the basis of the offset estimation value is described.

For easy understanding, contents, actions and effects of operations of the EPB-ECU 9 including the control unit, the offset estimation unit and the offset correction unit are described. The current sensor configured to detect the motor current may have an offset in the detection value due to individual differences, detection environments and the like. In this case, even when the current is controlled so that the detection value having the offset is equal to the target motor current value, since a value of current to be actually input to the motor is a value having the offset, target brake force may not be obtained. Therefore, the offset estimation unit determines an offset estimation value, the offset correction unit corrects the target motor current value on the basis of the determined offset estimation value, and the control unit executes the motor current control on the basis of the corrected target motor current value. Thereby, since the current to be input to the motor is controlled in a state in which at least a part of the offset is canceled, the favorable braking force can be obtained, as compared to a case in which the correction is not executed.

Also, when the vehicle is stopped on a sloping road as the execution of the motor current control is completed, the offset estimation unit determines the greater offset estimation value as a degree of variation in wheel speed of the vehicle for a predetermined time from the stop increases, for example (which will be described in detail later).

Also, when the offset estimation value determined by the offset estimation unit is equal to or greater than a predetermined value, the offset correction unit corrects the target motor current value on the basis of a predetermined upper limit value, for example (which will be described in detail later).

Also, when a temperature of the wheel brake mechanism is equal to or higher than a predetermined temperature upon the stop, the offset correction unit limits the correction of the target motor current value, for example (which will be described in detail later).

Also, when a situation in which the vehicle is not moved after the lock control at the time of the vehicle's stoppage continues for a predetermined time period or longer, the offset correction unit reduces an amount of correction of the target motor current value, for example (which will be described in detail later).

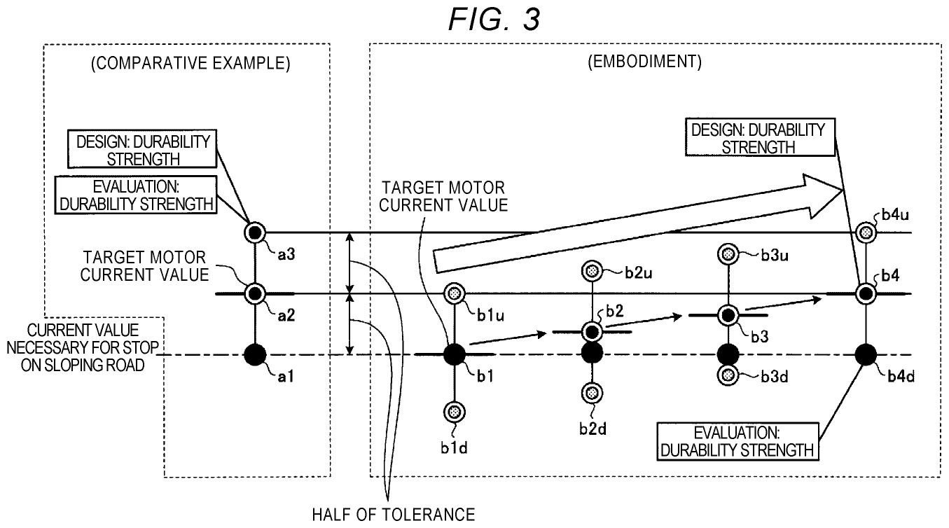

Subsequently, magnitudes of the target motor current values and the like in Comparative Example and the embodiment are described with reference to FIG. 3. FIG. 3 is an image view depicting magnitudes of the target motor current values and the like in Comparative Example and the embodiment.

In FIG. 3, a1 indicates a current value necessary for stop on a sloping road, i.e., a current value of the motor 10 for generating the parking brake force necessary for a vehicle stopped on a sloping road to keep the stop state. a3 indicates a current value obtained by adding a tolerance of the detection value of the current value of the motor 10 to the current value a1. a2 is a current value between a1 and a3. In Comparative Example (related art), the target motor current value is set to a2, not a1, considering the tolerance. That is, even when the detection value from the current sensor is a value greater than an actual current value by a half of the tolerance, the necessary current can be input to the motor 10. For this reason, the durability strength relating to designs and evaluations of the caliper 13, the actuator 7 and the like are tailored to a3.

Meanwhile, in the embodiment, the target motor current value is set to b1(a1). b1d is a value smaller than b1 by the half of the tolerance, and b1u is a value greater than b1 by the half of the tolerance (which applies to b2d to b4d and b2u to b4u, too). In this case, when the detection value from the current sensor is a value greater than the actual current value by the half of the tolerance, the necessary current is not input to the motor 10. Regarding this, when slide-down (a vehicle is stopped on a sloping road and is then moved downward on the sloping road after the lock control) occurs, the target motor current value is thereafter increased, as required, so as to cope with the slide-down.

Specifically, the lock control is executed with the target motor current value being set to b1, and increases the target motor current value to b2 when the slide-down occurs. When the slide-down occurs still, the target motor current value is increased to b3. Also, when the slide-down occurs still, the target motor current value is increased to b4. In this way, the target motor current value is increased in accordance with a result of the control, so that there is no problem even if the initial target motor current value is set to b1. Thereby, for the caliper 13, the actuator 7 and the like, the durability strength relating to the design can be tailored to b4 (a2) and the durability strength relating to the evaluation can be tailored to b1 (b4d, a1), for example. That is, the caliper 13, the actuator 7 and the like can be reduced in size and power can be saved by lowering the durability strength relating to the design and evaluation.

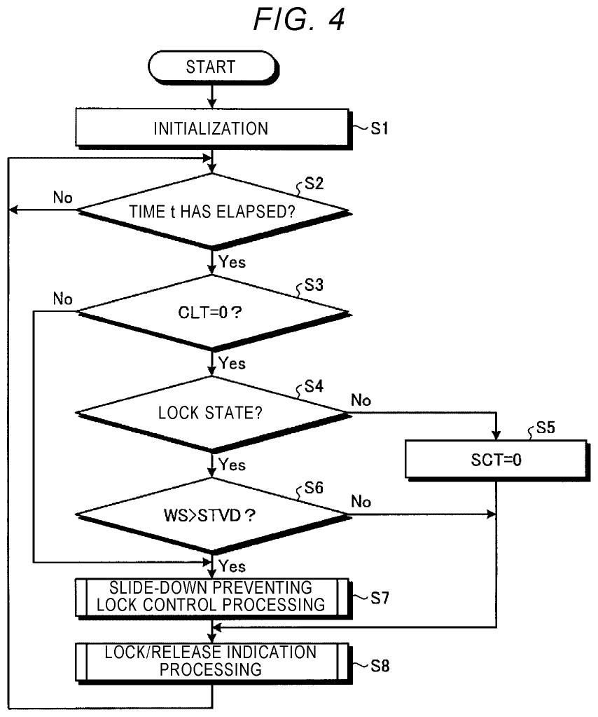

Subsequently, lock control processing that is to be executed by the braking control device of the embodiment is described with reference to FIG. 4. FIG. 4 is an overall flowchart of the lock control processing that is to be executed by the braking control device (EPB-ECU 9) of the embodiment.

First, the EPB-ECU 9 performs general initialization processing of resetting various counters, timers, flags and the like, in step S1.

Then, the EPB-ECU 9 determines in step S2 whether time t has elapsed, and proceeds to step S3 when the determination is Yes, and returns to step S2 when the determination is No. Herein, time t prescribes a control period. That is, the determination in this step is repeatedly performed until time t elapses since the initialization processing is over or since the affirmative determination (Yes) was made in the previous step. Thereby, whenever time t elapses, the parking brake control is executed.

In step S3, the EPB-ECU 9 determines whether a CLT (lock drive time timer) is zero (i.e., under the lock control), and proceeds to step S4 when the determination is Yes, and proceeds to step S7 when the determination is No.

In step S4, the EPB-ECU 9 determines whether it is the lock state (i.e., a FLOCK (lock state flag) is ON), and proceeds to step S6 when the determination is Yes, and proceeds to step S5 when the determination is No. Herein, FLOCK indicates a flag that becomes ON when the EPB 2 is actuated and the control to the lock state is completed. When the FLOCK is ON, the actuation of the EPB 2 has been already completed, so that the desired brake force is generated. However, even when the FLOCK is ON, the slide-down may occur because the detection value of the motor current includes the offset, for example.

In step S5, the EPB-ECU 9 resets an SCT (slide-down count timer) to 0, and proceeds to step S8.

In step S6, the EPB-ECU 9 determines whether a WS (wheel speed) is greater than an STVD (slide-down determination threshold value), and proceeds to step S7 when the determination is Yes, and proceeds to step S8 when the determination is No. That is, when the slide-down occurs after the lock control on the vehicle, the determination in step S6 is Yes, and the processing proceeds to step S7.

In step S7, the EPB-ECU 9 executes slide-down preventing lock control processing, and proceeds to step S8. In step S8, the EPB-ECU 9 executes lock/release indication processing, and returns to step S2. The processing of steps S7 and S8 will be described in detail later.

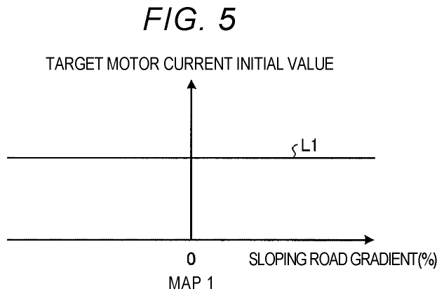

Herein, FIG. 5 is a map 1 depicting a relation between a sloping road gradient and a target motor current initial value. In the map 1 of FIG. 5, the target motor current initial value (L1) is constant, irrespective of magnitudes of the sloping road gradient (%). On the basis of the map 1 stored in the EPB-ECU 9, the EPB-ECU 9 can determine the target motor current initial value upon execution of the lock control. In the meantime, the map is not limited to the map 1, and a map may be used in which the greater the sloping road gradient (%) is, the greater the target motor current initial value is.

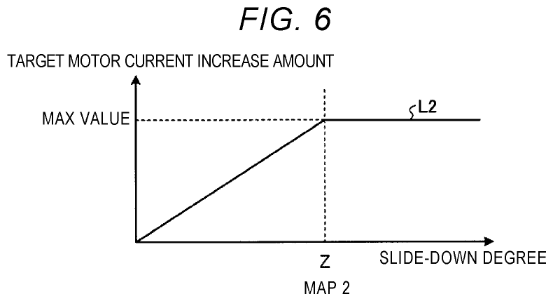

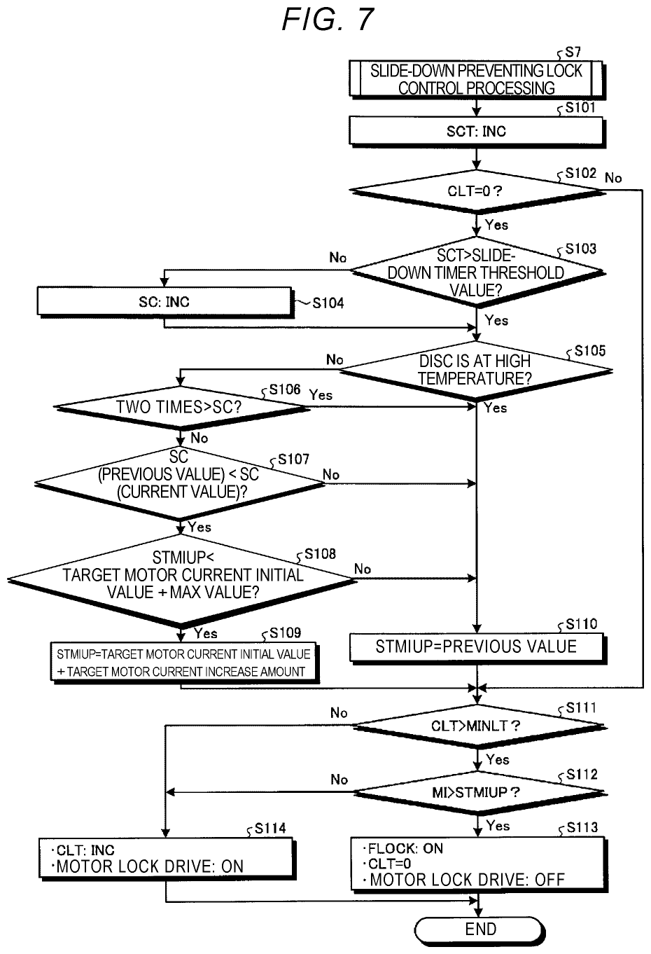

Subsequently, a map 2 that is to be used in a flowchart of FIG. 7 is described with reference to FIG. 6. FIG. 6 is the map 2 depicting a relation between a slide-down degree and a target motor current increase amount. In the meantime, the slide-down degree is a degree of slide-down that is to be determined in correspondence to the number of times of slide-down and an increase rate of the wheel speed, for example.

In the map 2 of FIG. 6, as the slide-down degree increases, the target motor current increase amount (L2) increases (a step form, other than a linear form, may also be possible) from the slide-down degree 0 to a predetermined value Z. When the slide-down degree is equal to or greater than the predetermined value Z, the target motor current increase amount is constant at a MAX value. The map 2 is stored in the EPB-ECU 9.

Subsequently, the processing of step S7 in FIG. 4 is described with reference to FIG. 7. FIG. 7 is a flowchart depicting the detailed slide-down preventing lock control processing of the overall flowchart of the lock control processing of FIG. 4.

In step S101, the EPB-ECU 9 increments (INC) the SCT (slide-down count timer).

Then, in step S102, the EPB-ECU 9 determines whether the CLT (lock drive time timer) is zero (i.e., under the lock control), and proceeds to step S103 when the determination is Yes, and proceeds to step S111 when the determination is No.

In step S103, the EPB-ECU 9 determines whether the SCT (slide-down count timer) is greater than the predetermined slide-down timer threshold value (for example, about 3 seconds), and proceeds to step S105 when the determination is Yes, and proceeds to step S104 when the determination is No.

In step S104, the EPB-ECU 9 increments (INC) the SC (slide-down count (number of times)), and proceeds to step S105.

In step S105, the EPB-ECU 9 determines whether a temperature of a DISC (brake disc) is higher than a predetermined temperature, based on a detection signal from the temperature sensor 28, and proceeds to step S110 when the determination is Yes, and proceeds to step S106 when the determination is No. That is, even when the slide-down has occurred, if the brake disc is at a high temperature, there is a high possibility that the high temperature is a cause. Therefore, in this case, the target motor current value is not changed.

In step S106, the EPB-ECU 9 determines whether the SC (slide-down count (number of times)) is less than two times, and proceeds to step S110 when the determination is Yes, and proceeds to step S107 when the determination is No. That is, when the slide-down is less than two times, the target motor current value is not changed.

In step S107, the EPB-ECU 9 determines whether the SC (current value) is greater than the SC (previous value), and proceeds to step S108 when the determination is Yes, and proceeds to step S110 when the determination is No. That is, when the value of SC does not increase, the target motor current value is not changed.

In step S108, the EPB-ECU 9 determines whether STMIUP (target motor current value for slide-down prevention) is less than “target motor current initial value+MAX value” by referring to the map 2 (FIG. 6), and proceeds to step S109 when the determination is Yes, and proceeds to step S110 when the determination is No. The processing of step S108 is executed so that the target motor current value is not to exceed a value obtained by adding the MAX value to the target motor current initial value.

In step S109, the EPB-ECU 9 sets, as the STMIUP (target motor current value for slide-down prevention), a value obtained by adding the target motor current increase amount (FIG. 6) to the target motor current initial value (i.e., sets a value obtained by adding an increment of the target motor current increase amount to the previous value), and proceeds to step S111.

In step S110, the EPB-ECU 9 sets, as the STMIUP (target motor current value for slide-down prevention), the previous value, and proceeds to step S111.

In step S111, the EPB-ECU 9 determines whether the CLT (lock drive time timer) exceeds MINLT (setting time for inrush current mask), and proceeds to step S112 when the determination is Yes, and proceeds to step S114 when the determination is No. In the meantime, the CLT (lock drive time timer) is a counter configured to measure elapsed time since the lock control is initiated, and is configured to start the count at the same time as the initiation of the lock control processing. The MINLT (setting time for inrush current mask) is a minimum time assumed to be consumed for the lock control, and is a value preset in correspondence to the rotating speed of the motor 10 and the like. The processing of step S111 is executed so as to mask the initial control and to prevent erroneous determination due to the inrush current by comparing the CLT (lock drive time timer) with the MINLT (setting time for inrush current mask).

In step S112, the EPB-ECU 9 determines whether MI (detection value of the motor current) is greater than the STMIUP (target motor current value for slide-down prevention), and proceeds to step S113 when the determination is Yes, and proceeds to step S114 when the determination is No.

In step S113, the EPB-ECU 9 sets the FLOCK (lock state flag) to ON, sets the CLT (lock drive time timer) to zero, and sets (stops) the motor lock drive to OFF. Thereby, the rotation of the motor 10 is stopped, the rotation of the rotary shaft 17 is stopped, and the propeller shaft 18 is held in the same position by the frictional force due to the engagement between the male screw groove 17a and the female screw groove 18a, so that the brake force generated at that time is kept. Thereby, the movement of the vehicle is restrained during the parking.

In step S114, the EPB-ECU 9 increments (INC) the CLT (lock drive time timer), and sets the motor lock drive to ON, i.e., rotates forward the motor 10. Thereby, the spur gear 15 is driven in conjunction with the forward rotation of the motor 10, the spur gear 16 and the rotary shaft 17 are rotated, the propeller shaft 18 is moved toward the brake disc 12 on the basis of the engagement between the male screw groove 17a and the female screw groove 18a, and the piston 19 is correspondingly moved in the same direction, so that the brake pad 11 is moved toward the brake disc 12.

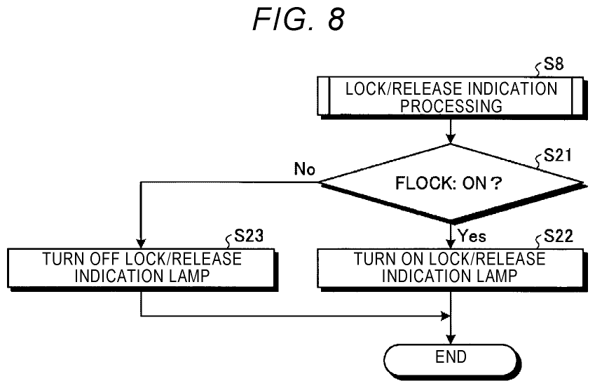

Subsequently, the processing of step S8 shown in FIG. 4 is described with reference to FIG. 8. FIG. 8 is a flowchart depicting detailed lock/release indication processing (step S8) of the overall flowchart of the lock control processing of FIG. 4.

In step S21, the EPB-ECU 9 determines whether the FLOCK (lock state flag) is ON, and proceeds to step S22 when the determination is Yes, and proceeds to step S23 when the determination is No.

In step S22, the EPB-ECU 9 turns on the lock/release indication lamp 24. In step S23, the EPB-ECU 9 turns off the lock/release indication lamp 24. In this way, the lock/release indication lamp 24 is turned on in the lock state, and the lock/release indication lamp 24 is turned off in a state except the lock state, so that it is possible to cause the driver to recognize whether it is in the lock state.

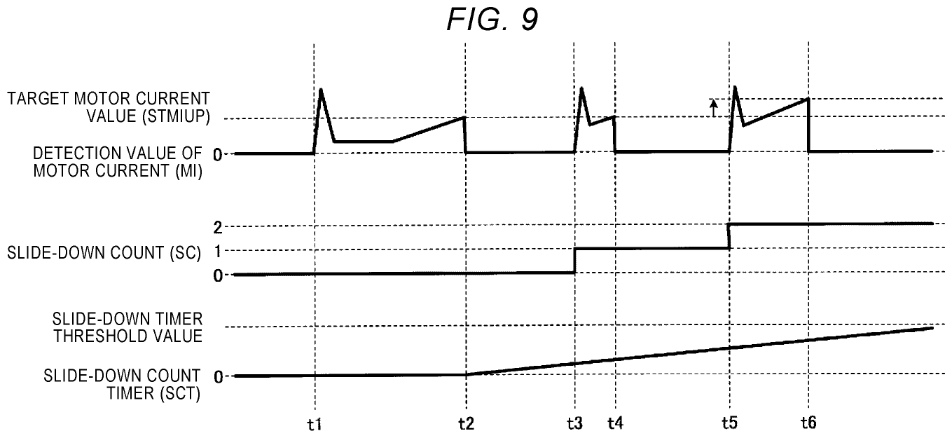

Subsequently, an example of a case in which the processing of FIG. 4 is executed to increase the target motor current value is described with reference to FIG. 9. FIG. 9 is a timing chart depicting an example of a case of increasing the target motor current value. Herein, it is assumed that the vehicle is parked on a sloping road.

At time t1, the operation SW 23 is operated by the driver, so that the lock control for parking is initiated. Then, at time t2, the MI (detection value of the motor current) becomes greater than the STMIUP (target motor current value for slide-down prevention) (Yes in step S112 in FIG. 7), so that the lock control is once completed (step S113 in FIG. 7).

Thereafter, the vehicle is slid down due to the offset in the detection value from the current sensor, so that the WS (wheel speed) becomes greater than the STVD (slide-down determination threshold value) (Yes in step S6 in FIG. 4). Then, at time t3, the increment of the SCT (slide-down count timer) is initiated. When the SCT is equal to or less than the slide-down timer threshold value (No in step S103 in FIG. 7), the SC (slide-down count (number of times)) is incremented from. “0” to “1” (step S104 in FIG. 7), and the motor lock drive (lock control) becomes ON (step S114 in FIG. 7).

Thereafter, at time t4, the lock control is once completed (step S113 in FIG. 7). Then, the vehicle is further slid down, so that the WS (wheel speed) becomes greater than the STVD (slide-down determination threshold value) (Yes in step S6 in FIG. 4). Then, at time t5, when the SCT (slide-down count timer) is equal to or less than the slide-down timer threshold value (No in step S103 in FIG. 7), the SC (slide-down count (number of times)) is incremented from “1” to “2” (step S104 in FIG. 7), the motor lock drive (lock control) becomes ON (step S114 in FIG. 7), and a value obtained by adding the target motor current increase amount (FIG. 6) to the target motor current initial value is set as the STMIUP (target motor current value for slide-down prevention) (i.e., a value obtained by adding the increment of the target motor current increase amount to the previous value is set) (step S109 in FIG. 7). Then, at time t6, the lock control is once completed (step S113 in FIG. 7).

Like this, according to the EPB-ECU 9 (braking control device) of the embodiment, it is not necessary to set the slightly high target motor current value. Specifically, in the EPB-ECU 9, the offset estimation unit determines the offset estimation value, the offset correction unit corrects the target motor current value on the basis of the determined offset estimation value, and the control unit executes the motor current control on the basis of the corrected target motor current value.

For example, as shown in FIG. 3, the target motor current value is set to b1, and when the slide-down occurs, the target motor current value is then increased, as required, so that there is no problem even if the initial target motor current value is set to b1. Thereby, it is possible to set the durability strength relating to the design and evaluation of the caliper 13, the actuator 7 and the like lower than the related art. The durability strength of the design and evaluation is lowered, so that the caliper 13, the actuator 7 and the like are reduced in size and power is saved.

Also, as shown in the map 2 of FIG. 6, as the slide-down degree increases (for example, as the degree of variation in wheel speed increases), the target motor current increase amount is set greater, so that it is possible to increase the target motor current value, as appropriate.

Also, in the case in which the temperature of the wheel brake mechanism (for example, the brake disc) is equal to or higher than the predetermined temperature, even when the slide-down has occurred, there is a high possibility that the high temperature of the wheel brake mechanism is a cause. In this case, it is possible to limit the unnecessary correction of the target motor current value (i.e., the correction is not performed).

Also, there is a high possibility that the offset of the detection value from the current sensor is permanent. Therefore, when the target motor current value has been once increased, it is preferable to continuously use the increased target motor current value. However, there may be a case in which the slide-down occurs and the target motor current value increases due to change in temperature depending on seasons and movement of the vehicle to high-temperature regions, for example. Therefore, when a situation in which the vehicle is not moved (no slide-down occurs) after the lock control based on the increased target motor current value continues for a predetermined time period (for example, one month) or longer, the offset correction unit of the EPB-ECU 9 may reduce a correction amount of the target motor current value (i.e., may reduce the target motor current value (for example, return the same to the original value). By doing so, it is possible to set the appropriate target motor current value according to the situations.

Although the embodiment of the present invention has been described, the embodiment is just exemplary and is not intended to limit the scope of the invention. The embodiment can be implemented in other various forms, and can be diversely omitted, replaced, combined and changed without departing from the gist of the invention. Also, the specification (structure, type, the number, and the like) of each configuration, shape and the like can be appropriately changed for implementation.

For example, in the embodiment, when the slide-down has occurred two times, the target motor current value is increased. However, the number of times is not limited to the two times and may be one time or three times or more. Also, the target motor current value may be increased when the degree of variation in wheel speed upon the slide-down is high, not the number of times of the slide-down.

Also, the timing at which the target motor current value is increased is not limited to the initiation of the lock control, and may be during the lock control or after the end of the previous lock control.

Also, in order to recognize the occurrence of slide-down, a detection signal of the front/rear acceleration G from the front/rear G sensor 25 may be used, instead of the wheel speed.

Also, the offset correction unit of the EPB-ECU 9 may correct the detection value from the current sensor, not the target motor current value, on the basis of the offset estimation value. Also in this case, it is possible to obtain the similar operational effects.

1-5. (canceled)

6. A braking control device to be applied to a vehicle provided with an electric parking brake having a wheel brake mechanism to be driven by a motor, the braking control device comprising:
a control unit configured to execute motor current control of controlling, on the basis of a target motor current value, which is a target value of current to be input to the motor, and a detection value from a current sensor configured to detect the current to be input to the motor, the current to be input to the motor so that the detection value from the current sensor is equal to the target motor current value;
an offset estimation unit configured to determine an offset estimation value, which is an estimated value of an offset of the detection value from the current sensor, on the basis of a behavior of the vehicle after lock control at the time of vehicle's stoppage; and
an offset correction unit configured to correct the target motor current value or the detection value from the current sensor on the basis of the offset estimation value.

7. The braking control device according to claim 6, wherein
when the vehicle is stopped on a sloping road as the execution of the motor current control is completed, the offset estimation unit determines the greater offset estimation value as a degree of variation in wheel speed of the vehicle for a predetermined time from the stop increases.

8. The braking control device according to claim 7, wherein
when the offset estimation value determined by the offset estimation unit is equal to or greater than a predetermined value, the offset correction unit corrects the target motor current value or the detection value from the current sensor on the basis of a predetermined upper limit value.

9. The braking control device according to claim 7, wherein
when a temperature of the wheel brake mechanism is equal to or higher than a predetermined temperature at the time of the vehicle's stoppage, the offset correction unit limits the correction of the target motor current value or the detection value from the current sensor.

10. The braking control device according to claim 8, wherein
when a temperature of the wheel brake mechanism is equal to or higher than a predetermined temperature at the time of the vehicle's stoppage, the offset correction unit limits the correction of the target motor current value or the detection value from the current sensor.

11. The braking control device according to claim 7, wherein
when a situation in which the vehicle is not moved after the lock control at the time of the vehicle's stoppage continues for a predetermined time period or longer, the offset correction unit reduces an amount of correction of the target motor current value or the detection value from the current sensor.

12. The braking control device according to claim 8, wherein
when a situation in which the vehicle is not moved after the lock control at the time of the vehicle's stoppage continues for a predetermined time period or longer, the offset correction unit reduces an amount of correction of the target motor current value or the detection value from the current sensor.
